(19) United States
(12) Patent Application Publication
(10) Pub. No.: US 2025/0200316 A1
(43) Pub. Date: Jun. 19, 2025

(54) ELECTRICAL DEVICE

(71) Applicant: CANON KABUSHIKI KAISHA, Tokyo (JP)

(72) Inventors: HIDEYUKI UEKI, Tokyo (JP); YOSUKE EZUMI, Ibaraki (JP); TAKUHIRO OGUSHI, Kanagawa (JP); YUKINORI NISHIKAWA, Kanagawa (JP); TAKAHIRO AIDA, Tokyo (JP)

(21) Appl. No.: 19/070,750

(22) Filed: Mar. 5, 2025

Related U.S. Application Data
(63) Continuation of application No. PCT/JP2023/025227, filed on Jul. 7, 2023.

(30) Foreign Application Priority Data
Sep. 15, 2022 (JP) 2022-147211

(51) Int. Cl. G06K 15/00; B41J 29/393

(52) U.S. Cl. CPC G06K 15/406; B41J 29/393; G06K 2215/101

(57) ABSTRACT

An electrical device includes a controlling unit configured to control the electrical device, a power supplying unit configured to supply power to the controlling unit, and a power controlling unit configured to control supply and interruption of power with regard to the controlling unit by the power supplying unit. In a case where the controlling unit receives a supply of power from the power supplying unit under control of the power controlling unit, the controlling unit executes different processing based on whether or not the supply of power is a first supply of power after power-on with regard to the power supplying unit.

### CROSS-REFERENCE TO RELATED APPLICATIONS

This application is a Continuation of International Patent Application No. PCT/JP2023/025227, filed Jul. 7, 2023, which claims the benefit of Japanese Patent Application No. 2022-147211, filed Sep. 15, 2022, both of which are hereby incorporated by reference herein in their entirety.

### BACKGROUND OF THE INVENTION

### Field of the Invention

The present invention relates to an electrical device.

### Background Art

A technology is known in which, while a commercial power source is being supplied to an electrical device, all or part of the circuitry of the electrical device is switched on or off by software in response to an operation performed on a power key. Japanese Patent Laid-Open No. 2012-175496 discloses a technology in which, in an electrical device having such a function, on and off states are stored when the commercial power supply is cut off, such as during a power outage, and then when the power supply is restored, the stored information is used to distinguish between on and off states.

When an electrical device is transported, the operating positions of internal mechanisms may become displaced, and the usage environment (e.g., external light amount) may differ depending on where the device is installed. For this reason, when an electrical device is powered on, processing related to preparation for use, such as initialization and calibration, is executed. Note that as long as the installation location of the electrical device does not change, this processing does not need to be repeated. However, when a configuration is adopted in which the power is switched on and off by software in response to an operation performed on a power key, if such processing related to preparation for use is performed each time the power is turned on, unnecessary processing may be repeatedly executed, and it may take a long time before the electrical device can be used.

### SUMMARY OF THE INVENTION

The present invention provides a technique for performing necessary processing when the power is turned on, while also preventing the processing from being unnecessarily repeated.

According to an aspect of the present invention, there is provided an electrical device comprising: a controlling unit configured to control the electrical device; a power supplying unit configured to supply power to the controlling unit; and a power controlling unit configured to control supply and interruption of power with regard to the controlling unit by the power supplying unit, wherein in a case where the controlling unit receives a supply of power from the power supplying unit under control of the power controlling unit, the controlling unit executes different processing based on whether or not the supply of power is a first supply of power after power-on with regard to the power supplying unit.

Further features of the present invention will become apparent from the following description of exemplary embodiments with reference to the attached drawings.

### BRIEF DESCRIPTION OF THE DRAWINGS

FIG. 1 is an external view of an electrical device according to an embodiment of the present invention.

FIG. 2 is an illustrative diagram showing an internal mechanism of the electrical device of FIG. 1.

FIG. 3 is a block diagram of a control unit of the electrical device of FIG. 1.

FIG. 4 is an illustrative diagram of operations when the power is turned on.

FIG. 5 is an illustrative diagram of operations when a power key is operated.

FIG. 6 is an illustrative diagram of operations when the power key is operated.

FIG. 7 is a block diagram of the storage unit.

FIG. 8 is a timing chart showing changes in hard-on information.

FIG. 9A is a flowchart showing an example of processing during startup of a system control unit.

FIG. 9B is a flowchart showing an example of processing during startup of the system control unit.

FIG. 10 is a flowchart showing an example of other processing during startup of the system control unit.

FIG. 11 is a timing chart showing changes in hard-on information.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### Overview of Electrical Device

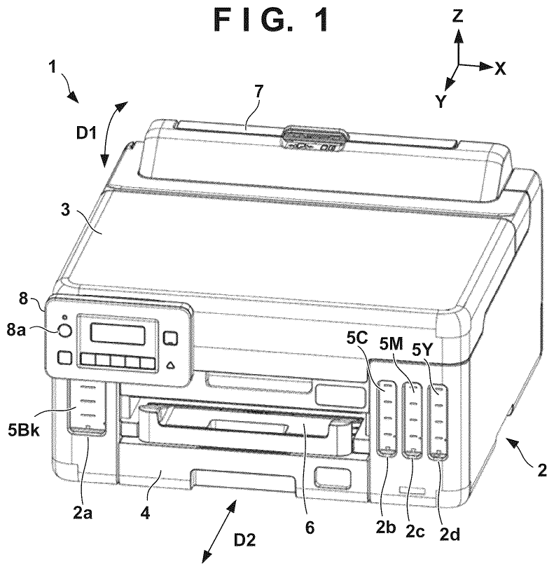

FIG. 1 is an external view of an electrical device 1 according to an embodiment of the present invention, as viewed from the front side. The electrical device 1 of the present embodiment is an inkjet printing apparatus that ejects liquid ink to perform printing on a printing medium, but the present invention is also applicable to various electrical devices other than inkjet printing apparatuses. In the figures, arrows X and Y indicate horizontal directions that are orthogonal to each other, and an arrow Z indicates the up-down direction (the direction of gravity). The X direction is the width direction (left-right direction) of the electrical device 1. The Y direction is the depth direction of the electrical device 1.

Note that “printing” includes not only formation of significant information such as a character or graphic pattern but also formation of an image, design, or pattern on print media in a broader sense and processing of print media regardless of whether the information is significant or insignificant or has become obvious to allow human visual perception. Also, in this embodiment, “printing medium” is assumed to be sheet-shaped paper but may be a fabric, a plastic film, or the like.

The electrical device 1 has a flattened rectangular parallelepiped shape as a whole, and includes an apparatus body 2, a cover 3, and a cassette-type stacking portion 4. The cover 3 is provided so as to cover the upper portion of the apparatus body 2 and constitutes the top portion of the electrical device 1. The cover 3 is a movable portion that can be operated by a user, and can be opened and closed in the direction of an arrow D1. FIG. 1 shows the cover 3 in a closed state. When the cover 3 changes to an open state, the internal mechanism of the apparatus body 2 can be exposed to the outside for maintenance or the like. The stacking portion 4 is a tray on which printing media are stacked, and is a movable portion that can be operated by the user and can be pulled out from and mounted in (pushed into) the apparatus body 2 in the direction of an arrow D2. A discharge portion 6, which is for discharging a printing medium on which printing was performed, is formed at the front of the electrical device 1. An operation unit 8 that accepts operations performed by a user is also provided at the front of the electrical device 1. The operation unit 8 has a touch panel type of display unit and a power key 8a. In the present embodiment, the power key 8a is a push button type of switch. By operating the power key 8a, the user can issue a power-on instruction and a power-off instruction to the electrical device 1.

A housing forming the outer walls of the apparatus body 2 has a plurality of window portions 2a to 2d. A user can visually check the internal configuration of the apparatus body 2 through the window portions 2a to 2d. In the present embodiment, the user can visually check the remaining amount of liquid contained in containers 5Bk, 5C, 5M, and 5Y (hereinafter, simply called the containers 5 when collectively referred to or when no distinction is made between them) through window portions 2a to 2d. The containers 5 are ink tanks that contain liquid ink, and different types of ink are contained in the four containers 5. In the case of the present embodiment, the container 5Bk contains black ink, the container 5C contains cyan ink, the container 5M contains magenta ink, and the container 5Y contains yellow ink. Also, the number of types of ink is not limited to four as in the present embodiment, and may be one type or a number of types other than four types, and the number of containers 5 need only be greater than or equal to the number of types of liquid ink.

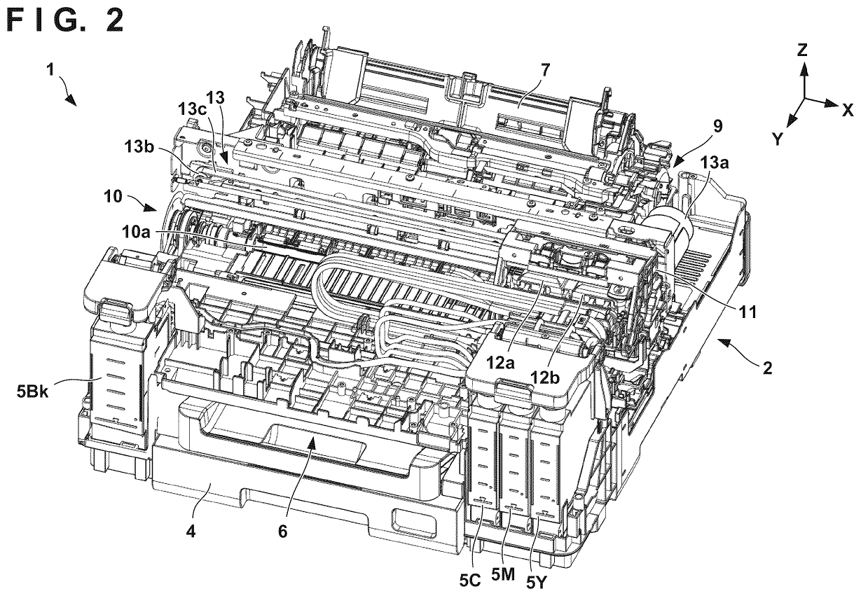

FIG. 2 is an illustrative diagram showing the internal mechanism of the electrical device 1. The electrical device 1 includes ejection heads 12a and 12b that eject liquid (hereinafter, simply called the containers 5 when collectively referred to or when no distinction is made between them). In the present embodiment, the ejection head 12a is a printing head that performs printing by ejecting ink supplied from the container 5Bk onto a printing medium, and the ejection head 12b is a printing head that performs printing by ejecting ink supplied from the containers 5C to 5Y onto a printing medium. The ejection heads 12 each have an ejection face on which a plurality of nozzles for ejecting ink are formed. Each nozzle is provided with, for example, an electrothermal conversion element (heater), which is heated when supplied with power to cause the formation of bubbles in the ink, and the resulting bubbling energy causes the ink to be ejected.

The ejection heads 12 are mounted on a carriage 11. The carriage 11 is moved back and forth in the X direction (main scanning direction) by a drive unit 13. The drive unit 13 includes a drive pulley and a driven pulley (only the driven pulley 13b is shown in FIG. 2) that are spaced apart in the X direction, an endless belt 13c wound around the pulleys, and a carriage motor 13a serving as a drive source for rotating the drive pulley. The carriage 11 is coupled to the endless belt 13c, and the carriage 11 moves in the X direction when the endless belt 13c moves. As the carriage 11 moves, ink is ejected from the ejection heads 12 onto the printing medium, thereby printing an image. This operation is sometimes called printing scanning.

As described above, the electrical device 1 of the present embodiment is a serial-type inkjet printing apparatus in which the ejection heads 12 are mounted on the carriage 11 that moves back and forth. However, the present invention can also be applied to other printing apparatuses, such as an inkjet printing apparatus that includes a “full line” head ejection head (printing head) provided with a plurality of nozzles that eject liquid over an area corresponding to the width of the printing medium.

The electrical device 1 includes a feeding unit 9 and a conveying unit 10 that convey printing media. The feeding unit 9 includes a feeding mechanism (not shown) that feeds printing media from the stacking portion 4 or a tray 7 onto which printing media are stacked. The feeding mechanism includes, for example, a feeding roller that feeds the printing media, and a feeding motor serving as a drive source that rotates the feeding roller. The conveying unit 10 is a mechanism for conveying the printing media fed from the feeding unit 9 in the Y direction (sub scanning direction). The conveying unit 10 includes a conveying roller 10a and a conveying motor serving as a drive source for rotating the conveying roller 10a. A pinch roller (not shown) is in pressure contact with the conveying roller 10a, and a printing medium is sandwiched in the nip region between them. The printing medium is intermittently conveyed toward the ejection head 12 by the rotation of the conveying roller 10a. The printing operation is performed by alternately repeating the printing medium conveying operation, which is performed by the conveying unit 10, and printing scanning.

### <Control Unit>

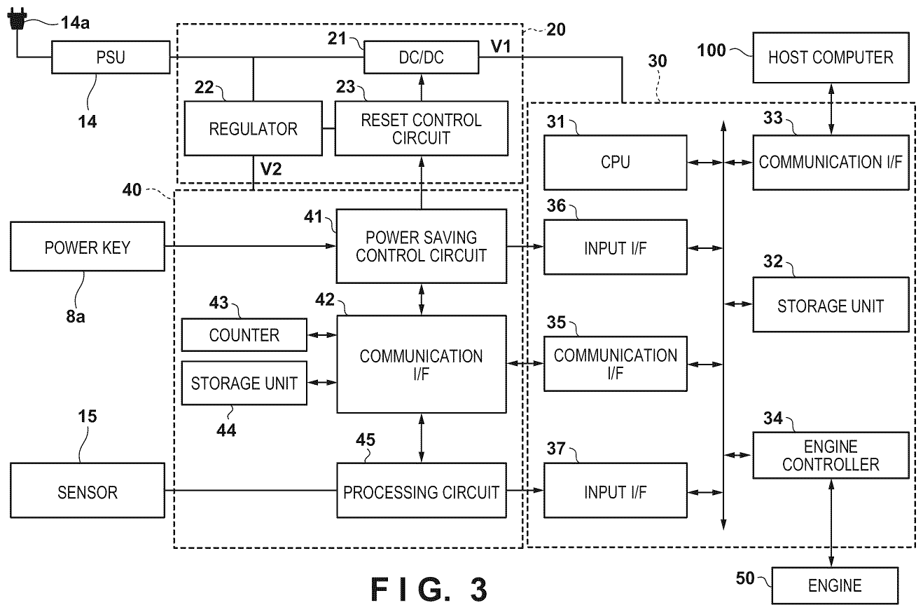

FIG. 3 is a block diagram of a control unit provided in the electrical device 1. The control unit is an electrical circuit that controls the electrical device 1. The control unit includes a power supply unit 20, a system control unit 30, and a power control unit 40.

The system control unit 30 is a control circuit (e.g., an ASIC) that performs overall control of the electrical device 1. The CPU 31 is a processor that, for example, controls operations of the electrical device 1 and controls the processing of data. The CPU 31 executes a program stored in a storage unit 32 to perform overall control of the electrical device 1. The storage unit 32 is constituted by a semiconductor memory (e.g., a ROM or a RAM). The storage unit 32 stores programs executed by the CPU 31 and various data required for processing, such data received from a host computer 100. An engine controller 34 includes, for example, a driver that controls an engine 50. The engine 50 includes components related to the printing operation (e.g., the ejection head 12, the feeding unit 9, the conveying unit 10, and various sensors).

The host computer 100 is, for example, a personal computer or a mobile terminal (such as a smartphone or tablet terminal) used by a user. A printer driver for performing communication between the host computer 100 and the electrical device 1 is installed in the host computer 100. The electrical device 1 includes a communication interface (communication I/F) 33, and communication between the host computer 100 and the CPU 31 is carried out via the communication I/F 33.

An input interface (input I/F) 36 has an input port to which a signal from a power control unit 41 is input, and in particular, to which a signal indicating a detection result regarding a user operation performed on the power key 8a is input. A communication interface (communication I/F) 35 performs data communication with a communication interface (communication I/F) 42 of the power control unit 41.

An input interface (input I/F) 37 has an input port to which a detection result from a sensor 15 is input. The sensor 15 is a sensor that detects, for example, the opening and closing of the cover 3 and the pushing in and pulling out of the stacking portion 4. The detection result of the sensor 15 is input to the input I/F 37 via a processing circuit 45, and the processing circuit 45 is provided in the power control unit 40.

When a plug 14a is inserted into an electrical outlet, a power supply unit (PSU) 14 converts commercial AC voltage into a DC voltage used by the electrical device 1, such as 32 V or 24 V, and outputs the DC voltage to the power supply unit 20. The state in which the plug 14a has been inserted into an outlet and the PSU 14 has started supplying power is also referred to as a hard-on state.

The power supply unit 20 is a circuit that supplies power to the system control unit 30, and includes a DC/DC converter 21, a regulator 22, and a reset control circuit 23. The DC/DC converter 21 converts the DC voltage output from the PSU 14 into a predetermined DC voltage V1 and supplies the converted DC voltage to the system control unit 30. The regulator 22 converts the DC voltage output from the PSU 14 to a predetermined DC voltage V2 and supplies the converted DC voltage to the power control unit 40 and the reset control circuit 23.

The reset control circuit 23 is a circuit that switches between the output of the voltage V1 by the DC/DC converter 21 and stopping the output. Upon receiving a stop output instruction (called a reset instruction) from the power saving control circuit 41, the reset control circuit 23 stops the output of the voltage V1 from DC/DC converter 21 (called a reset state). Furthermore, when the power saving control circuit 41 receives an instruction to cancel the reset state, the reset control circuit 23 causes the DC/DC converter 21 to output the voltage V1.

The power control unit 40 operates while receiving power from the regulator 22, and controls the supply and interruption of power with regard to the system control unit 30 by the power supply unit 20. The power saving control circuit 41 controls the transmission of the reset instruction to the reset control circuit 23 and the cancellation of the reset instruction. In other words, the power state of the system control unit 30 is controlled by the power saving control circuit 41 of the power control unit 40, the power saving state is entered when a reset instruction is output, and the power supply state is entered when the reset state is cancelled.

In the present embodiment, the power saving state is a standby state in which the supply of power to the system control unit 30 is interrupted, and the power consumption of the system control unit 30 is zero. Since the supply and interruption of power with regard to the system control unit 30 is performed by software, in the present embodiment, the power saving state is also called a soft-off state, and the power supply state in which a printing operation can be performed is also called a soft-on state. Note that the regulator 22 always outputs the voltage V2 as long as power is being supplied from the PSU 14, regardless of whether the regulator 22 is in the reset state or the reset state has been cancelled.

The power saving control circuit 41 receives an operation detection result pertaining to the power key 8a. The power saving control circuit 41 inputs the operation detection result pertaining to the power key 8a to the input I/F 36 of the system control unit 30. Therefore, in the soft-on state, the system control unit 30 can also recognize the operation state of the power key 8a.

During a hard-on (when the regulator 22 starts supplying the voltage V2), the power saving control circuit 41 controls the output of the reset instruction and the cancellation of the reset state based on the operation detection result pertaining to the power key 8a and a signal received from the system control unit 30 via the communication I/F 42.

The power control unit 40 also includes a counter 43, a storage unit 44, and a processing circuit 45. The counter 43 is capable of counting time. The counter 43 has a slow clock that can count, for example, once every 50 milliseconds, and by counting the clock signal, it is possible to, for example, measure time with low power consumption in the soft-off state.

The storage unit 44 can hold a specific value depending on the operation of the electrical device 1. In the present embodiment, the storage unit 44 holds information related to a hard-on. The count value of the counter 43 and the value held in the storage unit 44 can be acquired by the system control unit 30 via the communication I/F 42.

The processing circuit 45 is a circuit that has a function of outputting the detection result of the sensor 15 to the system control unit 30, and also has a function of holding the detection result. For example, in the soft-off state, the detection result is held in the processing circuit 45, and in the soft-on state, the system control unit 30 acquires the held detection information. Accordingly, the state of the electrical device 1 in the soft-off state can be recognized by the system control unit 30 in the soft-on state.

In the present embodiment, power consumption is reduced by cutting off the supply of power to the system control unit 30 in the soft-off state. Meanwhile, the power state of the system control unit 30 can be controlled by the power control unit 40, which is configured with a relatively small-scale circuit. This allows the electrical device 1 to achieve necessary functions while also significantly reducing power consumption.

In the present embodiment, even in the soft-off state, power is supplied to the communication I/F 42, but power is not supplied to the system control unit 30 that is the communication partner, and therefore communication is not performed. Therefore, a configuration may be adopted in which power is not supplied to the communication I/F 42 in the soft-off state.

### <Power State Transition Examples>

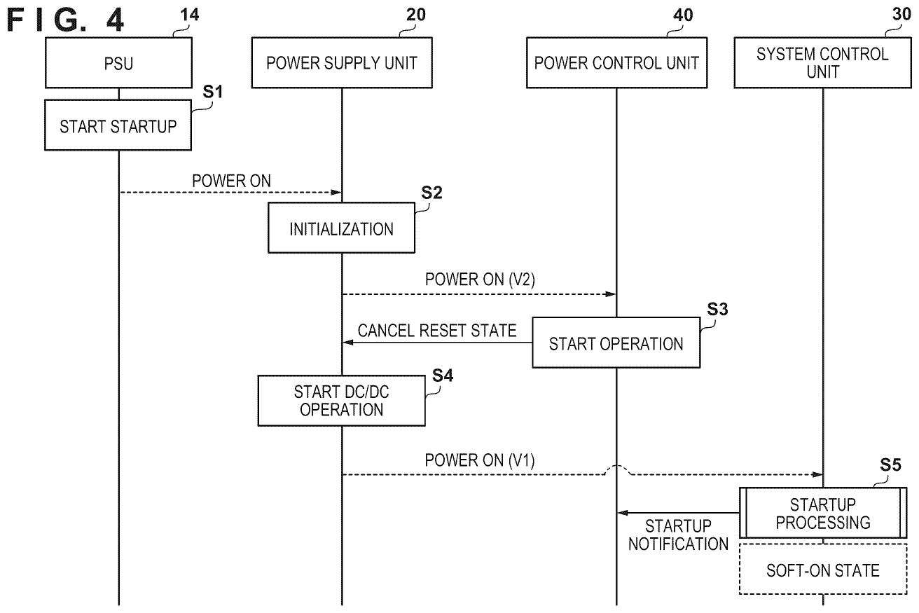

Examples of power state transitions and operations of the system control unit 30 will be described below with reference to FIGS. 4 to 6. FIG. 4 shows an example of operations (a start-up sequence) of the PSU 14, the power supply unit 20, the power control unit 40, and the system control unit 30 during a hard-on. Operations similar to those shown in FIG. 4 are also performed when commercial power is restored after a power outage.

The PSU 14 starts generating the power voltage used by the electrical device 1 (step S1). The DC voltage generated by the PSU 14 is supplied to the power supply unit 20 (power on), that is to say, power is supplied to the power supply unit 20. The power supply unit 20 is initialized, and the regulator 22 starts outputting the DC voltage V2 (step S2). The DC voltage V2 is supplied to the power control unit 40 (power on (V2)). The power control unit 40 starts operating (step S3), and an internal reset of the power control unit 40 is performed. The power saving control circuit 41 cancels the reset state of the reset control circuit 23 of the power supply unit 20.

When the reset state is cancelled, the reset control circuit 23 causes the DC/DC converter 21 to start operating (step S4). The DC voltage V1 is supplied from the DC/DC converter 21 to the system control unit 30 (power on (V1)). The CPU 31 of the system control unit 30 executes startup processing in accordance with a program stored in the storage unit 32 (step S5). When the startup is complete, the system control unit 30 transmits a startup notification to the power control unit 40.

Thereafter, when the system control unit 30 detects, for example, a power-on operation pertaining to the power key 8a, the system control unit 30 transitions to the soft-on state. The period from when the DC voltage V1 is supplied to the system control unit 30 until the transition to the soft-on state is sometimes referred to as a standby state. As another example of processing, for example, information set in advance by the user and stored in the storage unit 32 may be read out, and a selection may be made as to whether to set the soft-on state or the soft-off state.

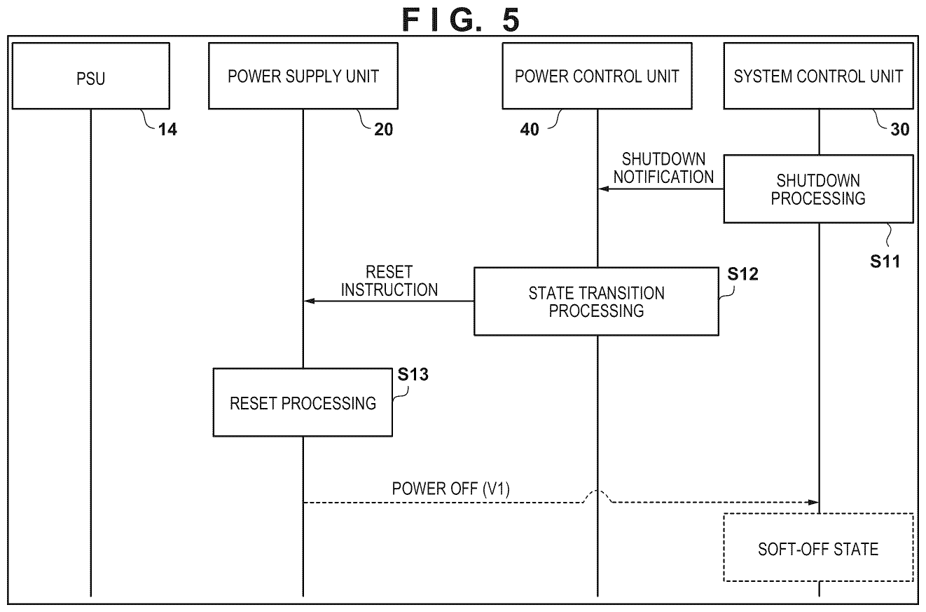

Next, a case where the user performs a power-off operation on the power key 8a in the soft-on state will be described with reference to FIG. 5.

When it is detected that a power-off operation was performed on the power key 8a in the soft-on state, it is then determined that the user has requested shutdown of the electrical device 1, and the system control unit 30 starts shutdown processing (step S11). Shutdown processing is processing in which the system control unit 30 prepares for a power interruption. When shutdown processing is completed, the system control unit 30 transmits a shutdown notification to the electronic control unit 40 via the communication I/F 35.

When the stop control unit 40 receives the shutdown notification, the power saving control circuit 41 issues a reset instruction to the power supply unit 20 as state transition processing (step S12). In response to the reset instruction, the reset control circuit 23 of the power supply unit 20 performs reset processing to stop the operation of the DC/DC converter 21 (step S13). The supply of the DC voltage V1 from the DC/DC converter 21 to the system control unit 30 is stopped (power off (V1)). The system control unit 30 transitions to the soft-off state.

Note that in the illustrated example, the system control unit 30 is caused to transition to the soft-off state on the condition that a power-off operation was performed on the power key 8a. However, similar operations may be performed when another condition is satisfied. For example, a configuration is possible in which a soft-off time is set, and when the set time arrives, the system control unit 30 transitions to the soft-off state by the operation in FIG. 5. As another example, the condition may be that no processing request has been received from the user for a certain period of time.

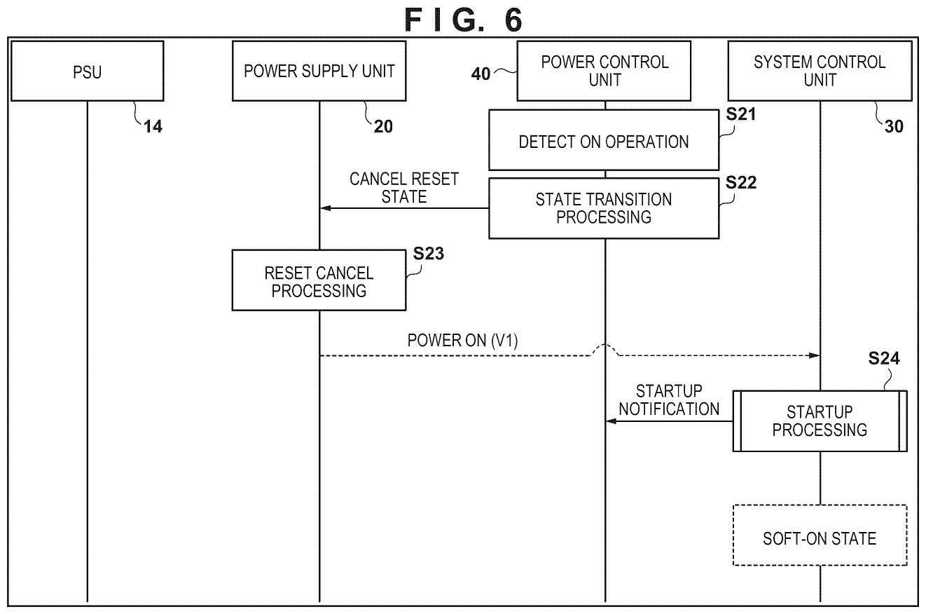

Next, a case where the user performs a power-on operation on the power key 8a in the soft-off state will be described with reference to FIG. 6. Since the system control unit 30 is stopped, the power-on operation is recognized by the power control unit 40 (power saving control circuit 41) (step S21). The power control unit 40 instructs the reset control circuit 23 to cancel the reset state, as state transition processing (step S22). The reset control circuit 23 of the power supply unit 20 performs reset cancel processing and causes the DC/DC converter 21 to start operating. Power is supplied from the DC/DC converter 21 to the system control unit 30 (power on (V1)).

When power is supplied, the CPU 31 of the system control unit 30 executes startup processing in accordance with a program stored in the storage unit 32 (step S24). When the startup is complete, the system control unit 30 transmits a startup notification to the power control unit 40. The system control unit 30 transitions to the soft-on state. In the power control unit 40, processing related to the startup of the system control unit 30 is executed.

### <Startup Processing>

Until a hard-on is performed, no power is supplied to the electrical device 1, and the electrical device 1 is in a completely stopped state. During transportation of the electrical device 1, the carriage 11 may undergo unintended displacement. Furthermore, depending on the installation environment (e.g., external light amount) of the electrical device 1, it may become necessary to perform calibration for ink ejection control. Therefore, when a hard-on is performed, the system control unit 30 needs to execute such processing related to initialization of the electrical device 1.

On the other hand, when the system control unit 30 is powered on (V1 supply), the CPU 31 executes a startup program from the storage unit 32. This startup program is basically the same when a hard-on is performed (step S5) and when a power-on operation is performed on the power key 8a (soft-on: step S24). During a hard-on, the need for the above initialization processing is high, whereas during a soft-on, the need for the above initialization processing is low. In fact, if such processing is performed every time a soft-on is performed, it will take a long time to prepare for the printing operation. Therefore, in the present embodiment, a mechanism for distinguishing between a hard-on and a soft-on is provided, and the system control unit 30 executes different processing during a hard-on and a soft-on, using the same startup program.

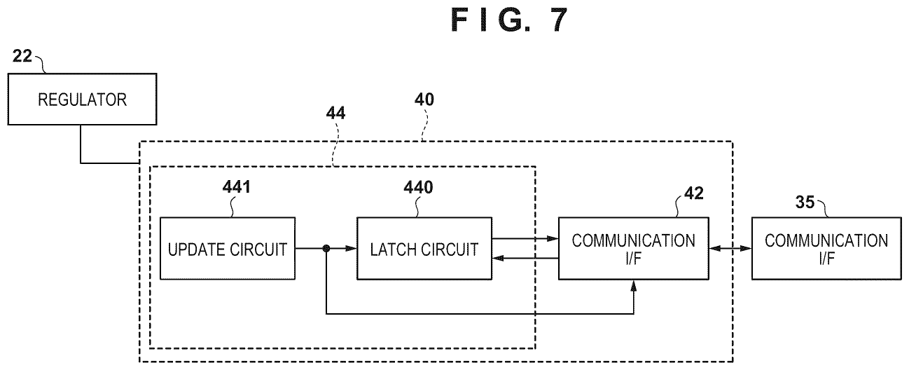

In order to distinguish between a hard-on and a soft-on, information indicating that a hard-on was performed immediately previously (called hard-on information) is held in the storage unit 44. FIG. 7 is a block diagram of the storage unit 44. The storage unit 44 includes a latch circuit 440 and an update circuit 441. The storage unit 44 receives a supply of power from the regulator 22, and is constantly supplied with power when the electrical device 1 is in the hard-on state.

In the present embodiment, the latch circuit 440 is a 1-bit holding circuit (here, a flip-flop circuit) whose initial value is a low level and which configures hard-on information in two states, namely the low level and a predetermined value (a high level in the present embodiment). When a hard-on is performed, the information is set to the low level, and is then rewritten to the high level. In other words, if the value (L,H) held in the latch circuit 440 is at the low level, this indicates a state immediately after a hard-on. In the present embodiment, if the value held in the latch circuit 440 is at the high level, this means that a soft-off has been performed at least once. In other words, this means that the startup processing of the system control unit 30 has been performed at least once.

The update circuit 441 outputs a reset signal to the latch circuit 440 when the regulator 22 starts supplying power. Upon receiving the reset signal, the latch circuit 440 clears the hard-on information to the initial value of low level, and the hard-on information is updated. The reset signal output by the update circuit 441 is also input to the communication I/F 42.

Also, the system control unit 30 can acquire the hard-on information held in the latch circuit 440 via the communication I/F 42, and can rewrite the hard-on information via the communication I/F 42. Rewriting of the hard-on information by the system control unit 30 is limited to only rewriting to the high level, and only the update circuit 441 can update the hard-on information to the low level.

In the present embodiment, a 1-bit flip-flop circuit is illustrated as an example of the latch circuit 440, but a 2-bit or more circuit may be used, and the initial value of the hard-on information may be the high level. Moreover, instead of the latch circuit 440, a general-purpose memory such as an SRAM or an SD-RAM can be used as the circuit for holding the hard-on information. When a high-capacity memory such as an SRAM or an SD-RAM is used, it can be used in combination with the memory used when the power control unit 40 performs other processing. Also, in the present embodiment, a configuration is adopted in which only the update circuit 441 can clear the hard-on information, and the hard-on information can only be cleared when power is received from the regulator 22, but a configuration may be adopted in which a circuit other than the update circuit 441 can clear the hard-on information.

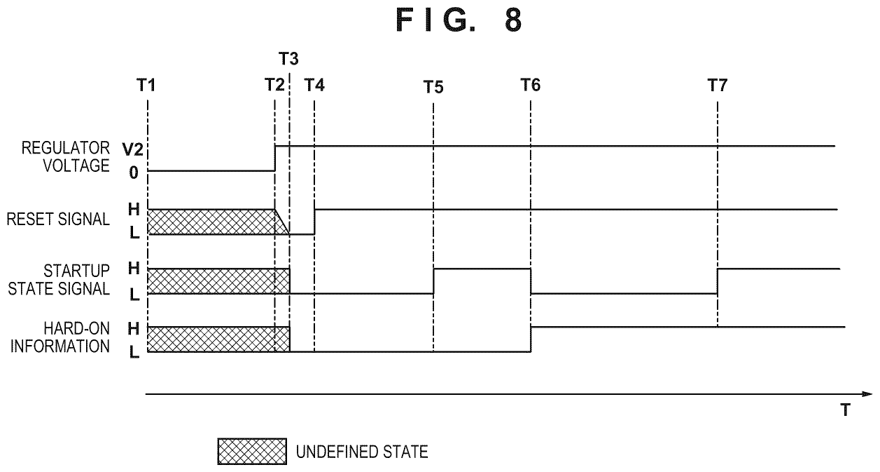

FIG. 8 is a timing chart showing operation of the storage unit 44, and in particular, a timing chart showing changes in the hard-on information. A time T1 indicates the timing when a hard-on is performed. When the plug 14a is inserted into a power outlet, the PSU 14 begins supplying power. The voltage V2 is not yet being output from the regulator 22. At this time, since the power control unit 40 has not been powered on, the hard-on information stored in the internal latch circuit 440 is undefined.

At a time T2, the regulator 22 starts up, and power is supplied to the power control unit 40. The update circuit 441 outputs the reset signal (low level signal) at a time t3. The latch circuit 440 receives the reset signal and then clears the hard-on information held therein. The hard-on information is set to the low level (0). The communication I/F 42 also receives the reset signal and performs initialization. Thereafter, the update circuit 441 stops outputting the reset signal, and the signal output from the update circuit 441 is set to the high level. At a time T5, the system control unit 30 also starts up, and a startup state signal transmitted from the system control unit 30 to the power control unit 40 is set to the high level (startup notification). The storage unit 44 is not influenced by the startup notification. After that, at a time T6, the system control unit 30 enters the soft-off state, and the startup state signal is set to the low level (shutdown notification). The hard-on information held in the latch circuit 440 according to the signal from the communication I/F 42 is set to the high level (1). At a time T7, the startup state signal is set to the high level (startup notification), but there is no change in the hard-on information. The value of the latch circuit 440 is cleared only when a hard-on is performed, and therefore the hard-on information is held at the high level (1) until a hard-on is performed.

In the present embodiment, the timing at which the hard-on information changes is the timing at which the startup state signal changes to the low level, but it may be another timing, such as the timing at which the startup state signal changes to the high level. The signal logic of the latch circuit 440 is also not limited to the above example, and can be determined according to the application.

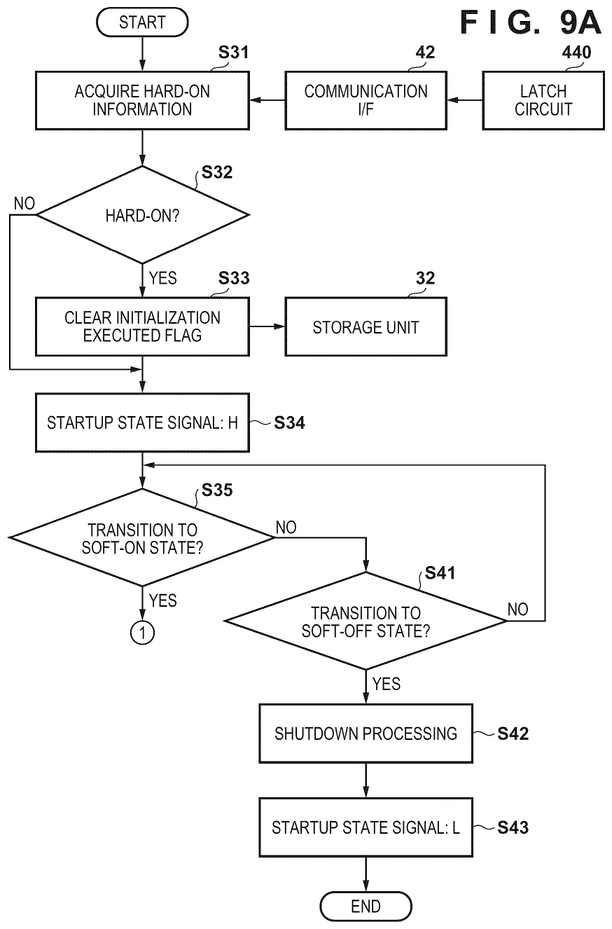

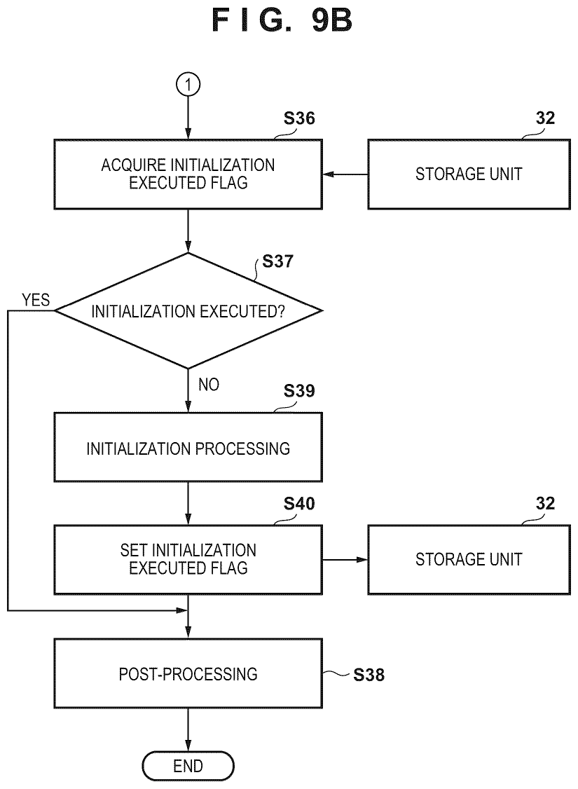

FIGS. 9A and 9B are flowcharts showing an example of processing executed by the CPU 31 of the system control unit 30 during startup, and show examples of processing executed in step S5 in FIG. 4 and step S24 in FIG. 6. After preparation for use of the communication I/F 35 to communicate with the power control unit 40, in step S31, the hard-on information stored in the storage unit 44 is acquired via the communication I/F 42 of the power control unit 40.

In step S32, it is determined whether the current supply of power (power on) to the system control unit 30 is the first supply after a hard-on. If the hard-on information is 0, it is determined to be the first time, and if the hard-on information is 1, it is determined to be the second or subsequent time (a soft-on in response to an operation performed on the power key 8a). If it is determined that the power supply is not the first time, the processing moves to step S34, and if it is determined that the power supply is the first time, the processing moves to step S33. In step S33, an initialization executed flag is cleared (set to 0). The initialization executed flag is a flag whose information is held in the storage unit 32, and is a flag that indicates whether or not the later-described initialization processing of step S39 has been executed, that is to say, when the value of the flag is 1, the initialization processing has been executed, and when the value of the flag is 0, the initialization processing has not been executed.

In step S34, the startup state signal is set to the high level (startup notification).

In step S35, it is determined whether or not the power state is to transition to the soft-on state. For example, when an ON operation is performed on the power key 8a, the power state transitions to the soft-on state. In the case of a transition to the soft-on state, the processing moves to step S36, and if otherwise, the processing moves to step S41.

In step S36, the initialization executed flag is acquired from the storage unit 32. In step S37, different processing is executed depending on the value of the initialization executed flag. If the initialization executed flag is 0, necessary processing has not been executed after a hard-on, and thus processing related to initialization is executed in step S39. If the initialization executed flag is 1, necessary processing has already been executed, and therefore the initialization processing in step S39 is skipped, and the processing moves to step S38. This makes it possible to prevent the processing of step S39 from being repeated unnecessarily.

In step S39, processing related to initialization of the electrical device 1 is performed. For example, processing is performed to cause an operating unit to perform a predetermined operation, such as movement of the carriage 11 to the home position, and correction processing such as various types of calibration processing is performed. In step S40, the initialization executed flag is set to 1 (set to “executed”). Accordingly, the processing related to initialization in step S39 will not be executed the next time a soft-on is performed or thereafter. In step S38, post-processing is executed.

In step S41, it is determined whether or not the power state is to transition to the soft-off state. For example, when a power off operation is performed on the power key 8a, or when a state without a user instruction continues for a predetermined period of time, the power state transitions to the soft-off state. In the case of a transition to the soft-off state, the processing moves to step S41, and if otherwise, the processing returns to step S35.

In step S42, shutdown processing is performed in preparation for the interruption of the supply of power with regard to the system control unit 30. In step S43, the startup state signal is set to the low level (shutdown notification). As a result, the supply of power to the system control unit 30 is interrupted by the power control unit 40. At this time, in the power control unit 40, the hard-on information held in the latch circuit 440 is set to the predetermined value (1).

As described above, according to the present embodiment, when power is supplied to the system control unit 30 from the power supply unit 20, different processing is executed depending on whether or not power is being supplied for the first time after the power supply unit 20 is turned on. In the present embodiment, the processing differs with respect to whether or not processing related to initialization is executed. Necessary processing is performed when the power is turned on, but unnecessary repetition of such processing is prevented, thereby shortening the startup time.

Note that the processing may differ with respect to processing other than whether or not processing related to initialization is executed as in the present embodiment. For example, in the case where power is supplied from the power supply unit 20 to the system control unit 30 when a hard-on is performed, the processing of step S39 is performed. Then, when the power state subsequently changes to the soft-on state, only part of the processing in step S39 (e.g., only movement of the carriage 11 to the home position) is performed, or other processing is performed.

### Second Embodiment

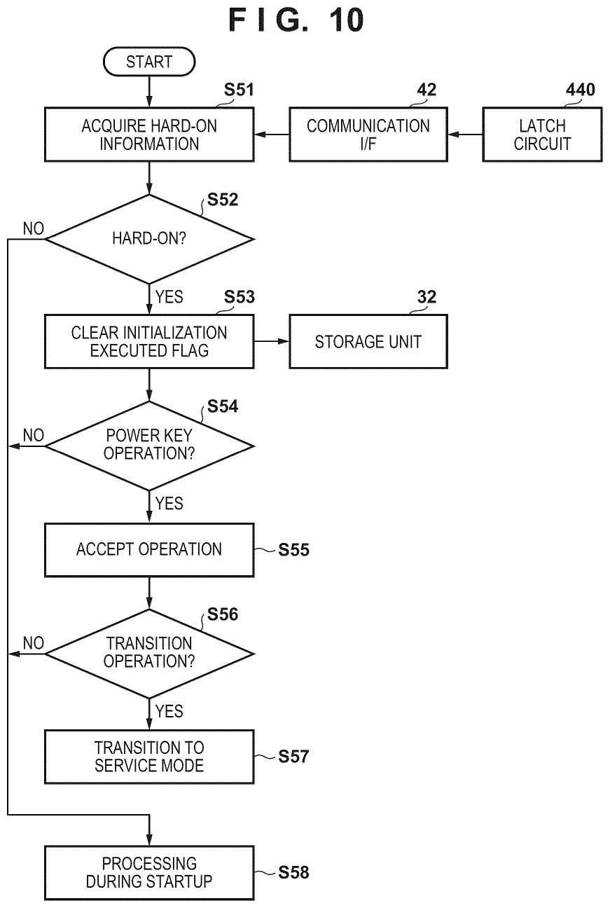

When a hard-on is performed, the state may transition to a service mode in which service processing can be executed. The service mode is a general term for an operation mode in which, for example, processing related to debugging for use in defect analysis and processing related to shipping inspection at the factory are carried out, and is an operation mode that is different from the services provided to normal users. Since this service mode is not a function provided to general users, the service mode is entered by a special key operation or at a special timing. Here, to prevent the user from mistakenly entering the service mode during use, the service mode is entered only when the power is turned on from outside the apparatus. FIG. 10 is a flowchart showing an example of processing of the present embodiment which replaces the processing example of FIGS. 9A and 9B.

After preparation for use of the communication I/F 35 to communicate with the power control unit 40, in step S51, the hard-on information stored in the storage unit 44 is acquired via the communication I/F 42 of the power control unit 40.

In step S52, it is determined whether the current supply of power (power-on) to the system control unit 30 is the first supply after a hard-on. If the hard-on information is 0, it is determined to be the first time, and if the hard-on information is 1, it is determined to be the second or subsequent time (a soft-on in response to an operation performed on the power key 8a). If it is determined that the power supply is not the first time, the processing moves to step S58, in which processing during startup (processing similar to steps S34 to S43 in FIGS. 9A and 9B) is performed.

If it is determined that the power supply is the first time, the processing moves to step S53, and the initialization executed flag is cleared (set to 0). In step S54, it is checked whether or not a power-on operation was performed on the power key 8a, and if the power-on operation was performed, the processing moves to step S55. In step S55, a predetermined operation for entering the service mode is accepted. The operation is accepted by, for example, a key of the operation unit 8. The service mode may be entered by pressing and holding a certain key, or by pressing specific keys in sequence. When a service technician performs a specific operation, the service mode is entered.

In step S56, it is determined whether or not the key operation satisfies a condition for entering the service mode. If the entry condition is satisfied, the processing moves to step S57 and the service mode is entered. If the entry condition is not satisfied, the processing moves to step S58.

In this manner, in the present embodiment, it is possible to provide a mechanism for determining whether or not to enter the service mode by utilizing the hard-on information.

### Third Embodiment

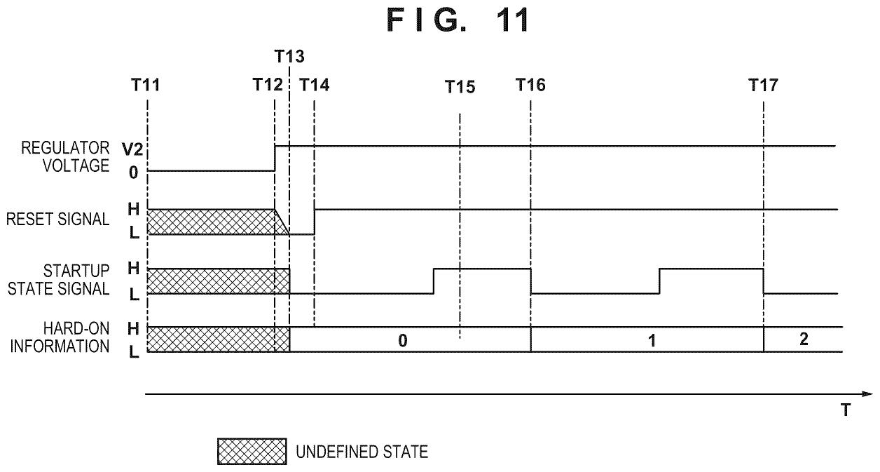

The hard-on information held in the latch circuit 440 may be a value other than the two values of high level and low level. FIG. 11 shows hard-on information in a case where the value is incremented according to the number of times the system control unit 30 is started up. In the configuration shown in FIG. 11, the hard-on count indicates the number of times that the supply of power to the system control unit 30 has been interrupted. When the startup state signal changes from the high level to the low level, the hard-on information is incremented. The hard-on information may be reset to 1 when an upper limit value is reached. Besides holding data that is incremented, the latch circuit 440 may hold a value that is decremented. In the present embodiment as well, the latch circuit 440 does not hold a value of 0 unless the latch circuit 440 has been initialized.

By storing a value indicating the number of times the system control unit 30 has been started up as hard-on information, it is possible to execute initialization processing (step S39) or other maintenance processing, for example, once every seven times the soft-on state is entered. One example of maintenance processing is processing for restoring the performance of the ejection heads 12a and 12b.

Also, specific processing may be performed when the hard-on information reaches an upper limit value. As a result, for example, in a device that learns usage by the user, until the upper limit value is reached, a learning start flag is set when the system control unit 30 is powered on, and usage by the user is learned during operation. When the hard-on information reaches the upper limit value, it is deemed that learning has been performed a predetermined number of times, and thereafter, learning is stopped and processing is switched according to the learning result. This makes it possible to provide services that are in accordance with usage by the user. In this case as well, rather than holding data that is incremented, the latch circuit 440 may hold a value that is decremented.

Furthermore, the stored hard-on information may be a number indicating the processing that is to be executed the next time the system control unit 30 is started up after the supply of power to the system control unit 30 is interrupted. For example, the identification number is set to 0 when the power is turned on by a hard-on, set to 1 when no processing is required, and set to 2 when regular maintenance processing is to be executed. At the timing when the startup state signal changes from the high level to the low level (shutdown notification), the identification number of the processing to be executed at the next startup may be stored in the latch circuit 440 by using the hard-on information.

### OTHER EMBODIMENTS

In the above embodiment, an inkjet printing apparatus is illustrated as an example of an electrical device, but the present invention can also be applied to other electrical devices. For example, the present invention can be applied to devices that read discs, such as CD players and HDD players. In this case, when the device is powered on, an operating unit initialization operation is performed to determine the position of the disk, but when an operation other than a hard-on is performed on the power key, the operation for determining the disk read position can be omitted.

In the above embodiment, the power supply unit 20 and the power control unit 40 are configured as separate ICs, but they may also be configured as a single IC.

In the above embodiment, there is one type of soft-on state, but the soft-on state may further have two types, namely a normal power supply state and a power saving state.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An electrical device comprising:
a controlling unit configured to control the electrical device;
a power supplying unit configured to supply power to the controlling unit; and
a power controlling unit configured to control supply and interruption of power with regard to the controlling unit by the power supplying unit,
wherein in a case where the controlling unit receives a supply of power from the power supplying unit under control of the power controlling unit, the controlling unit executes different processing based on whether or not the supply of power is a first supply of power after power-on with regard to the power supplying unit.

2. The electrical device according to claim 1, wherein
in a case where the supply of power is the first supply of power after power-on with regard to the power supplying unit, the controlling unit executes processing related to initialization of the electrical device, and in a case where the supply of power is not the first supply of power, the controlling unit does not execute the processing.

3. The electrical device according to claim 2, further comprising a first holding unit configured to hold first information that is updated upon power-on with regard to the power supplying unit,
wherein in a case where the controlling unit receives the supply of power from the power supplying unit under control of the power controlling unit, the controlling unit acquires the first information held by the first holding unit.

4. The electrical device according to claim 3, further comprising an updating unit configured to update the first information held in the first holding unit upon power-on with regard to the power supplying unit.

5. The electrical device according to claim 4, wherein
in a case where the supply of power from the power supplying unit to the controlling unit is interrupted under control of the power controlling unit, the first information held by the first holding unit is set to a predetermined value, and
the updating unit resets the first information held by the first holding unit upon power-on with regard to the power supplying unit.

6. The electrical device according to claim 4, wherein
the first information held by the first holding unit indicates a number of times the supply of power from the power supplying unit to the controlling unit has been interrupted under control of the power controlling unit, and
the updating unit resets the first information held by the first holding unit upon power-on with regard to the power supplying unit.

7. The electrical device according to claim 3, wherein
the controlling unit includes a second holding unit configured to hold second information indicating whether or not the processing has been executed,
in a case where the controlling unit receives the supply of power from the power supplying unit under control of the power controlling unit, the controlling unit acquires the second information and determines whether or not to execute the processing,
upon executing the processing, the controlling unit sets the second information to indicate that the processing has been executed, and
the controlling unit sets the second information to indicate that the processing has not been executed, based on the first information acquired in a case where the controlling unit receives the supply of power from the power supplying unit under control of the power controlling unit.

8. The electrical device according to claim 2, wherein
in a case where the supply of power is the first supply of power after upon power-on with regard to the power supplying unit, and it is detected that a specific operation was performed on the electrical device, the controlling unit executes service processing different from the processing.

9. The electrical device according to claim 8, wherein
the service processing includes at least either one of processing related to debugging and processing related to inspection.

10. The electrical device according to claim 2, wherein
the processing related to initialization includes processing for operating an operating unit included in the electrical device.

11. The electrical device according to claim 1, wherein
the power controlling unit causes power to be supplied to the controlling unit by the power supplying unit based on a power-on instruction from a user, and
the power controlling unit causes the supply of power to the control unit by the power supplying unit to be interrupted based on a power-off instruction from the user.

12. The electrical device according to claim 1, wherein
the electrical device is a printing apparatus configured to perform printing by ejecting a liquid onto a printing medium.
